(19) United States
(12) Patent Application Publication
(10) Pub. No.: US 2013/0011802 A1
(43) Pub. Date: Jan. 10, 2013

(54) METHOD AND DEVICE FOR HEATING A FILM

(75) Inventor: Dieter HOLZEM, Erolzheim (DE)

(73) Assignee: MULTIVAC SEPP HAGGENMULLER GMBH & CO. KG, Wolfertschwenden (DE)

(21) Appl. No.: 13/542,499

(22) Filed: Jul. 5, 2012

(30) Foreign Application Priority Data
Jul. 6, 2011 (DE) 102011106695.4

(51) Int. Cl. F27D 7/00; B65B 47/02

(52) U.S. Cl. 432/9; 432/226; 53/559

(57) ABSTRACT

The invention relates generally to a method for contact-free heating a thermoformable film prior to deforming the thermoformable film. Heating is carried out by at least one heater having at least one porous surface which faces the film and through which air flows. An air film is formed between the porous surface and the thermoformable film due to the flow of air through the porous surface. The invention also relates to a heating unit for contact-free heating a thermoformable film as well as to a packaging machine that includes such a heating unit.

### CROSS-REFERENCE TO RELATED APPLICATION

This Application claims priority to German Application Number 102011106695.4 filed Jul. 6, 2011 to Dieter Holzem entitled “Method and Device for Heating a Film,” currently pending, the entire disclosure of which is incorporated herein by reference.

### FIELD OF THE INVENTION

The invention relates generally to a method and device for heating a film.

### BACKGROUND

It is known that a thermoplastic material, provided in the form of a film, can be thermoformed when the film is heated such that the thermoplastic is in a thermoelastic range. Heating of the film can be accomplished by various heat transfer methods.

DE 197 43 157 A1, for example, discloses a case of use in which a film web is heated to a temperature in the thermoelastic range between two contact plates. Each of the two contact plates is fixedly or releasably connected to a heating plate which generates the necessary heat energy on the contact plate. A surface of the contact plate provided with an anti-stick coating transfers the heat of the heating plate through direct contact to the film web. The direct contact of the two components has a disadvantageous effect on some properties of the film to be processed. For example, an impression of the contact plate is formed on the film.

Hence, it would be desirable to avoid direct contact direct contact between a heating unit and the film to be heated. A method in which heating of the film to be deformed is carried out in a contact-free manner is known from DE 199 26 359 A1. The film is heated with the aid of infrared emitters to a temperature in the thermoelastic range of the thermoplastic. A drawback of this method is the high amount of energy required by the infrared emitters.

In addition, DE 10 2008 050 899 A1 discloses a device for moistening a flexible flat material, in which a steam discharge area is provided with steam discharge openings. For moistening the flexible flat material it is moved past a steam pressure cushion formed on the steam discharge area.

### SUMMARY OF THE INVENTION

It is the object of the present invention to provide a method and a heating unit which improve contactless heating of a thermoformable film.

The method according to the present invention is so conceived that, prior to being deformed, a thermoformable film is heated in a contact-free (contactless) manner by means of a heater. The heater has at least one porous surface which faces the film and through which air flows, an air film being formed between the porous surface and the film due to the flow of air through the porous surface. The fact that the film is thus positioned on the air film and is not in direct contact with the heater prevents the film from becoming opaque, which would be the case if it came into contact with the heater, and thereby allowing the production of highly transparent packages that are formed from the heated film. This method, which, other than the radiation or contact heaters according to the prior art, operates on the principle of convective heat transfer, also avoids any wear of the porous surface, which would be the case if a contact heater were used.

Because the air film flows around the film along a planar side of the film, it allows uniform heating of the film. Thus, a uniform temperature distribution within the film can be accomplished.

The heating power can additionally be increased by using one or more heaters. According to one embodiment of the invention, a second air film can be produced on the film side located opposite the first air film by means of a second heater, so that the film is disposed between two air films. In addition, heating can be distributed in various operating cycles and the operating process can thus be designed more freely. For example, a first heater may first heat the film to a temperature below the thermoelastic range, and one or more subsequent heaters may heat the film to the temperature required for thermoforming.

By applying a force, the film can be fixed on the air film so that the film occupies an adequate position on the air film and is held at this position.

In one embodiment of the invention, the force required for fixing the film is applied by pressurized air to the side located opposite the air film. Tool contact with the film is thus avoided.

The heating unit according to the present invention comprises a heater having at least one porous surface. The heating unit is suitable for the above-described embodiments of the method.

Therefore, it will be of advantage when the heater is configured for conducting air through the porous surface. According to another embodiment of the invention, the air can be conducted through the porous surface by means of air ducts. This allows precise guidance of the air flowing through.

The heater may be adapted to be moved relative to the film in a direction perpendicular to said film. Thus, the distance between the film and the heater can be adjusted according to requirements.

In addition, it may be of advantage when two or more heaters are provided in the heating unit, since this will lead to a corresponding increase in the heating power.

When a plurality of heaters is provided in the heating unit, it may be particularly advantageous when a first heater is disposed on a first planar side of the film and when a second heater is disposed on a second planar side of the film. The film is then located between the two heaters and can be heated uniformly and rapidly.

One heater of the heating unit may be stationary and the other heater may be disposed such that it is movable relative to the film. The distance between the heating unit and the film can thus be controlled in a flexible manner.

In one embodiment of the invention, heating unit comprises a housing. This may be particularly advantageous when the housing is configured for creating pressure differences with respect to a space surrounding the heating unit.

Additionally, the heating unit may include a punch for thermoforming the film The punch allows particularly efficient thermoforming, and advantageous properties of the product can be accomplished thereby. In one embodiment, the punch has formed thereon at least one porous surface. Special advantages can be accomplished when the punch is also configured for conducting air through the porous surface of the punch. This promotes an air film which is formed between the punch and the film and which effectively prevents direct contact between the punch and the film during the thermoforming process. The film is prevented from adhering to the punch and the formation of an impression of the punch on the film is inhibited. The film slides on the hot air film of the punch during thermoforming, so that the film can be expanded freely to all sides. This kind of arrangement also allows a production of complicated parts with a uniform wall thickness.

Further, it may of advantage when the porous surface is produced from an adequate material. Adequate materials may be sintered materials, cast materials, foamed materials or natural materials, such as stones, having sufficient porosity. Porous materials with microporous structures proved to be particularly expedient. Pore sizes in the range of from 0.5 μm to 15 μm, preferably 1 to 6 μm, proved to be particularly suitable, since air can be conducted through these pore sizes in a specially efficient manner. It will also be appreciated that only part of the pores have such a size. For accomplishing an optimum air permeability, at least 50% of the pores may have pore size values in the above-mentioned range, or even better 70% or ideally all the pores should have pore sizes in this range.

According to one embodiment of the invention, the porous surface of the heating unit is formed only partially, i.e. in certain areas, on the heating unit. In areas having no porous surface, no hot air film for heating the film will be formed, which means that these areas are not actively heated. Thus, different temperatures zones are obtained along the heating plate. These zones can be used in an advantageous manner for influencing the forming result.

The forming station according to the present invention is adapted for use with the above-described variants of the method and for accommodating the above-described heating unit.

The packaging machine according to the present invention is adapted for accommodating the above-described forming station and/or an above-described heating unit.

Other and further objects of the invention, together with the features of novelty appurtenant thereto, will appear in the course of the following description.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is a schematic side view of a packaging machine in accordance with one embodiment of the present invention; and

FIG. 2 is a schematic side view showing a portion of a packaging machine including, among other things, heating units in accordance with one embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

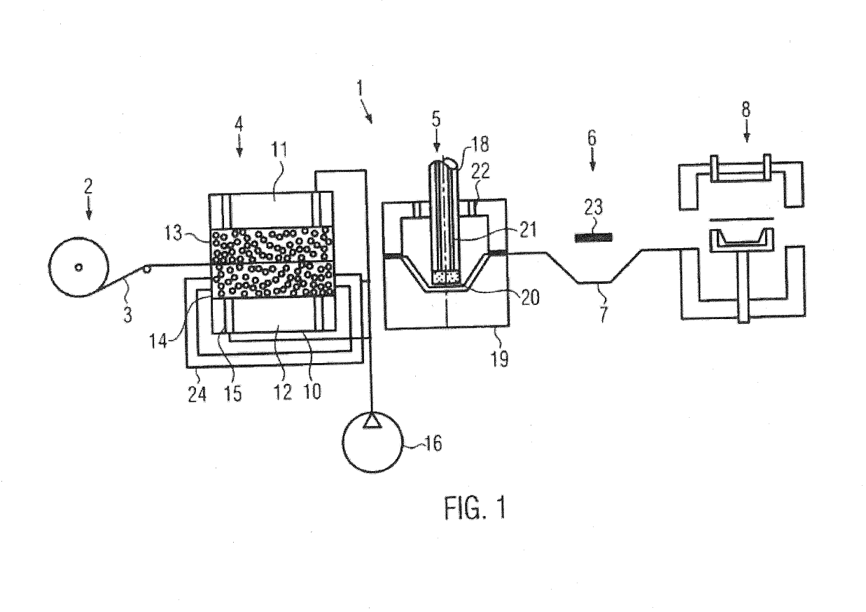

FIG. 1 shows in a schematic representation a packaging machine 1 in a side view. As illustrated, the packaging machine 1 may comprise a supply device 2 from which a film/foil 3 can be unwound, a heating unit 4 for heating the film 3, a forming station 5 for thermoforming the film 3, a filling station 6 for filling a package 7 as well as a sealing station 8 for evacuating, gas flushing and/or sealing a package 7 that has been thermoformed in the forming station 5.

The heating unit 4 is provided with a heater 9, which may be arranged such that the film 3 can be conveyed therebelow, and with a heater 10 disposed below the film 3 The two heaters 9, 10 each comprise a heating plate 11, 12 heated in a suitable way, e.g. by electric heating wires. The respective side of each heating plate 11, 12 facing the film 3 is provided with a porous surface 13, 14 produced, for example, from a porous sintered material. In one embodiment, the pore size of the porous surface 13, 14 ranges from 1 μm to 6 μm in order to achieve good air permeability. The porous surfaces 13, 14 can be formed integrally with the heating plates 11, 12 or they may be fixed or attached, e.g. by screw connections, to the heating plates 11, 12 as separate inserts. In addition, the heaters 9, 10 may be provided with one or more air ducts 15 extending from a compressor 16, which may be disposed in the interior or outside of the packaging machine, through the heating plates 11, 12 to the porous surfaces 13, 14.

In one embodiment, the forming station 5 comprises a thermoforming tool 17 with a punch 18 and a (female) die 19. The punch 18 can have a porous surface 20 at the end facing the film 3 to be thermoformed, said porous surface 20 be formed integrally with the punch 18 or connected thereto, for example, by means of a screw connection. The punch 18 additionally may include one or more air ducts 21 extending from a compressor, which is disposed in the interior or outside of the packaging machine 1, up to the porous surface 20 of the punch 18. It will be appreciated that the air ducts 21 of the punch 18 can also connected to the heating unit 4 so that the air supplied to the porous surface 20 of the punch 18 can be heated, or the punch 18 itself may be provided with heating elements (e.g., electric heating elements) so that the air flowing therethrough can be heated.

The method which is generally executable by the above described packaging machine is briefly described in the following.

In one embodiment of the method, the air conducted through the air ducts 15 flows through the porous surfaces 13, 14 such that an air film is formed along the porous surfaces 13, 14. While flowing through the porous surfaces 13, 14 the air is heated by the heat emitted by the heating plates 11, 12 so that the air film formed between the porous surfaces 13, 14 and the film 3 will have a temperature that generally corresponds to the temperature of the heating plates 11, 12. The temperature of the heating plates 11, 12 can be adjusted depending on the respective flow velocity of the conducted air. Generally speaking, the higher the flow velocity of the air is, the higher the necessary temperature of the heating plates 11, 12 will be. As can additionally be seen from FIG. 1, the air ducts 15 can be routed through the heating plates 11, 12 in such a way that the air conducted through the air ducts 15 will already be heated within the heated air ducts 15 prior to flowing through the porous surfaces 13, 14.

Alternatively, it would be imaginable that the air which is intended to flow through the porous surfaces 13, 14 circulates in a closed system 24, as indicated in FIG. 1. Such an arrangement has the effect that the air does not cool down significantly due to this circulation and the heating power of the heating plates 11, 12 can be reduced substantially. This leads to a reduced power demand for the heating unit 4.

Due to a force resulting from a movement of heating plate 12 towards heating plate 11, the film 3 can be held between the two air films formed on the porous surfaces 13, 14, so that the film 3 is fixed in a contactless manner between the two heating plates 11, 12 during the heating process. Due to the fact that the hot air film formed on the porous surfaces 13, 14 flows around the film 3, the latter is heated to a temperature which corresponds approximately to the temperature of the heating plates 11, 12 and which is chosen such that thermoforming will be allowed in the subsequent operating process.

The air conducted through the air ducts 21 may also flow through the porous surface 20 of the punch 18 shown in FIG. 1 and, due to the flow of air through said porous surface 20, an air film is formed along the latter. During the thermoforming process, this hot air film prevents direct contact between the heated film 3 and the porous surface 20 of the punch 18 and, consequently, an excessively rapid cooling down of the film. Due to the thermoforming process, the air between the film 3 and the punch 18 is generally compressed. This compression of air requires a large amount of energy and, consequently, it may be of advantage to discontinue the air film, i.e. the supply of air to the punch 18, during the thermoforming process for a short period of time.

The punch 18 first prestretches the film 3 mechanically in the direction of the die 19. Forming of the package 7 may then carried out by means of a vacuum applied to the die 19. The package 7 serves for packing a product 23 which can be supplied to the filling station 6. The product 23 may, for example, be a foodstuff or some other article. The package 7 containing the product 23 may be sealed in the sealing station 8.

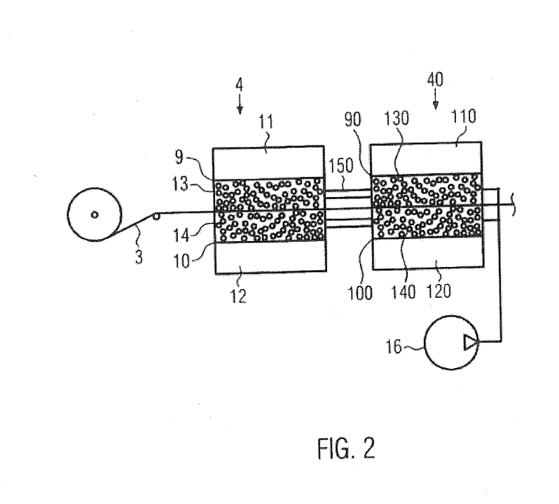

FIG. 2 shows in a schematic representation another embodiment of the packaging machine 1, only details of which are shown. In addition to the heaters 9, 10, two further subsequent heaters 90, 100 are provided in a heating unit 40. Like the heaters 9, 10, said additional heaters 90, 100 may each comprise a respective heating plate 110, 120 and a respective porous surface 130, 140 connected to the heating plates 110, 120. The compressor 16 may conduct air into the porous surfaces 130, 140 in the heaters 90, 100 in a flow direction generally parallel to the film 3, whereby, due to the flow of air through the porous surfaces 130, 140, a respective air film is formed along said porous surfaces 130, 140 between the latter and the planar surfaces of the film 3. Due to the contact of the porous surfaces 130, 140 with the heating plates 110, 120, the air flowing therethrough is heated so that the air film formed will have a temperature similar or equal to the temperature of the heating plates 110, 120. As illustrated, the heaters 90, 100 are connected to the heaters 9, 10 through air ducts 150, so that, after having passed through the porous surfaces 130, 140, the hot air film will be advanced to the heaters 9, 10 (or vice versa) where it will flow through the porous surfaces 13, 14 of said heaters 9, 10 and heat the film 3 also there. Alternatively, the heated air may pass first through heaters 9, 10 and then through heaters 90, 100. When the heating plates 11, 12 of the heaters 9, 10 are activated, the hot air film, which cools down as a result of flowing and transferring heat to the film 3, may be reheated by the heating plates 11, 12 so that the film 3 is heated in both heating units 4, 40 with approximately the same temperature difference. The heating unit 4 may, however, also comprise additional heaters.

It would, however, also be imaginable that only the heaters 90, 100 are provided with active heating plates 110, 120 and that the hot air is not reheated in the heaters 9, 10, but that only the residual heat from the heaters 90, 100 is utilized. The film 3 can thus be heated more slowly, i.e. with a lower temperature rise gradient, to the temperature required for thermoforming.

The heaters 9, 10 or 90, 100 need not necessarily be arranged in pairs. Depending on the respective case of use, it would also be imaginable that only one planar side of the film 3 is heated. Also a combination of double-sided planar and one-sided planar heating of the film 3 would be possible.

In addition, it would be imaginable that the circulation of the air through the system 24 shown in FIG. 1 is combined with a heating arrangement according to FIG. 2. Making use of such an arrangement, which is not shown, a circulation between a plurality of successive heaters would be possible.

Another embodiment of the invention is so conceived that the heaters 9, 10 have a further porous surface which is arranged precisely on the heater side located opposite the porous surface 13. Thus, it would be possible to heat a respective film above and below the heater 9.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for contactless heating of a thennoformable film prior to deforming said thermoformable film, wherein the contactless heating is carried out by at least one heater having at least one porous surface which faces the thermoformable film and through which air flows, an air film being formed between the porous surface and the thermoformable film due to the flow of air through the porous surface.

2. The method of claim 1, wherein the air film additionally prevents direct contact between the thermoformable film and the heater.

3. The method of claim 1, wherein while flowing through the porous surface, the air is heated by the heater through a transfer of heat thereby forming a hot said air film between the porous surface and the thermoformable film.

4. The method of claim 1, wherein the air film flows around the thermoformable film along at least one planar side of a surface of said thermoformable film.

5. The method of claim 1, wherein at least two said heaters are provided for contactless heating of the thermoformable film, said heating of the thermoformable film being carried out in one or more work cycles.

6. The method of claim 1, wherein said heating is carried out by first and second said heaters, wherein said second heater forms a second said air film on a second planar side of the thermoformable film located opposite a first said air film formed by said first heater, and wherein the thermoformable film is disposed between the first and second air films.

7. The method of claim 1, wherein the thermoformable film is fixed on the air film by means of a force applied to the thermoformable film.

8. A heating unit for contact-free heating a thermoformable film, the heating unit comprising a heater having at least one porous surface which faces the thermoformable film.

9. The heating unit of claim 8, wherein the heater is configured for conducting air through the porous surface.

10. The heating unit of claim 9, wherein the air can be conducted through the porous surface by means of air ducts.

11. The heating unit of claim 8, wherein the heater is adapted to be moved relative to the thermoformable film in a direction generally perpendicular to said thermoformable film.

12. The heating unit of claim 8, wherein the heating unit includes two or more heaters.

13. The heating unit of claim 8 further comprising a punch for thermoforming the thermoformable film, said punch having formed thereon at least one porous surface facing the thermoformable film.

14. The heating unit of claim 13, wherein the porous surface includes pores ranging in size from about 0.5 μm to about 15 μm.

15. The heating unit of claim 8, wherein the heating unit is integrated with a forming station.

16. A packaging machine comprising a forming station including a heating unit for contact-free heating a thermoformable film, the heating unit comprising a heater having at least one porous surface which faces the thermoformable film.
